(19) United States
(12) Patent Application Publication
(10) Pub. No.: US 2020/0158337 A1
(43) Pub. Date: May 21, 2020

(54) COOKING DEVICE

(71) Applicant: GMG Products LLC, Lakeside, OR (US)

(72) Inventors: David W. BAKER, Lakeside, OR (US); Wang PING, Wuhan (CN)

(21) Appl. No.: 16/267,219

(22) Filed: Feb. 4, 2019

(30) Foreign Application Priority Data
Nov. 15, 2018 (CN) 2018218884373

(51) Int. Cl. F23J 1/02; A47J 37/07

(52) U.S. Cl. CPC F23J 1/02; A47J 37/0786; A47J 37/0722

(57) ABSTRACT

A heating assembly for a cooking device is provided herein. The heating assembly may include a burn box having a body defining a pot and a receptacle. The pot and receptacle can be separated from each other by a divider. An ignitor extends into the pot. A duct is fluidly coupled with the receptacle and is configured to extend between the receptacle and a housing surrounding the burn box. The duct defines an inlet within the receptacle and an outlet on the opposing end portion of the duct.

### CROSS-REFERENCE TO RELATED APPLICATIONS

This application claims priority to Chinese Patent Application No. CN2018218884373 filed on Nov. 15, 2018.

### FIELD OF THE INVENTION

The present disclosure generally relates to a heating assembly for a cooking device.

### BACKGROUND OF THE INVENTION

In some cooking devices, a fuel is burned to produce heat that produces a byproduct, such as ash, as a result of the burning process. For some cooking devices, it may be desirable to have a heating assembly that includes features for easing the removal of the byproduct.

### SUMMARY OF THE INVENTION

According to some examples of the present disclosure, a heating assembly for a cooking device is provided herein. The heating assembly includes a burn box having a body defining a pot and a receptacle. The pot and receptacle are separated by a divider. An ignitor extends into the pot. A duct is fluidly coupled with the receptacle and extends between the receptacle and a housing surrounding the burn box. The duct defines an inlet operably coupled with the receptacle and an outlet on an opposing end portion of the duct.

According to some examples of the present disclosure, a cooking device is provided herein that includes a housing defining a heating chamber. A heating assembly is operably coupled with the heating chamber. A burn box is positioned within the heating assembly and defines a pot and a receptacle separated by a divider. A duct is fluidly coupled with the receptacle on a first end portion and extends from the burn box towards the housing.

According to some examples of the present disclosure, a heating assembly for a cooking device is provided herein. The heating assembly includes a burn box configured to heat a heating chamber defined by a housing. The burn box has a body extending in a first direction. A duct is fluidly coupled with the burn box and extends between the burn box and the housing in a second, intersecting direction.

These and other aspects, objects, and features of the present invention will be understood and appreciated by those skilled in the art upon studying the following specification, claims, and appended drawings.

### BRIEF DESCRIPTION OF THE DRAWINGS

In the drawings:

FIG. 1 is a front perspective view of a cooking device having a lid positioned in an open position, according to some examples;

FIG. 2 is a front perspective view of the cooking device having the lid positioned in a closed position, according to some examples;

FIG. 3 is a front perspective view of a burn box positioned within a housing of the cooking device and operably coupled with a duct, according to some examples;

FIG. 4 is a side perspective view of the cooking device with the duct positioned proximate a side portion of the housing and a cover assembly positioned outwardly of the duct, according to some examples;

FIG. 5 is a front perspective view of the burn box defining a pot and a receptacle separated by a divider, according to some examples;

FIG. 6 is a side perspective view of the cooking device and a vacuum device operably coupled with the duct, according to some examples;

FIG. 7 is a block diagram illustrating the cooking device, an electronic device communicatively coupled with the cooking device, and the vacuum device, according to some examples; and

FIG. 8 is a block diagram of the cooking device, the electronic device, and the vacuum device each operably coupled with a remote server, according to some examples.

### DETAILED DESCRIPTION OF THE PREFERRED EXAMPLES

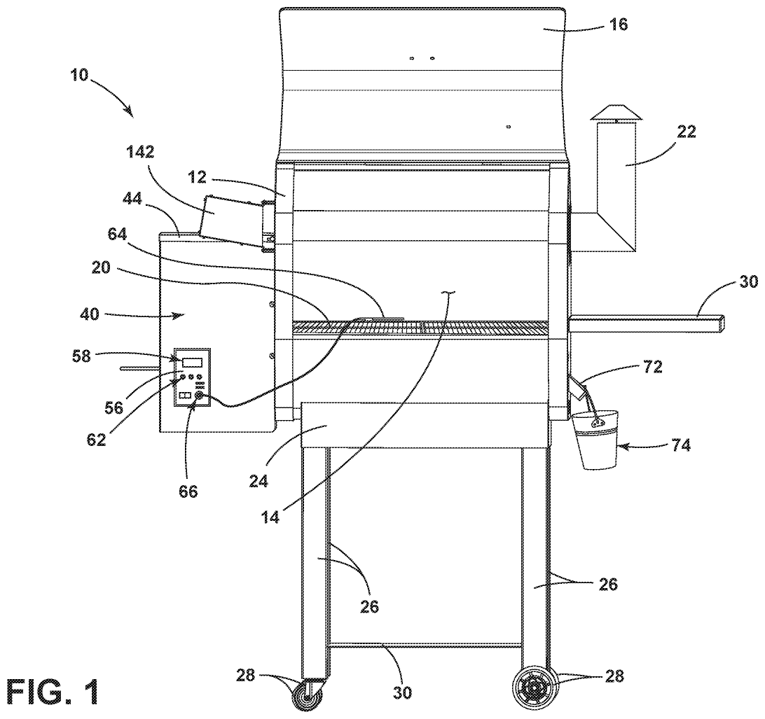

For purposes of description herein, the terms “upper,” “lower,” “right,” “left,” “rear,” “front,” “vertical,” “horizontal,” and derivatives thereof shall relate to the invention as oriented in FIG. 1. However, it is to be understood that the invention may assume various alternative orientations, except where expressly specified to the contrary. It is also to be understood that the specific devices and processes illustrated in the attached drawings, and described in the following specification are simply exemplary examples of the inventive concepts defined in the appended claims. Hence, specific dimensions and other physical characteristics relating to the examples disclosed herein are not to be considered as limiting, unless the claims expressly state otherwise.

As required, detailed examples of the present invention are disclosed herein. However, it is to be understood that the disclosed examples are merely exemplary of the invention that may be embodied in various and alternative forms. The figures are not necessarily to a detailed design and some schematics may be exaggerated or minimized to show function overview. Therefore, specific structural and functional details disclosed herein are not to be interpreted as limiting, but merely as a representative basis for teaching one skilled in the art to variously employ the present invention.

In this document, relational terms, such as first and second, top and bottom, and the like, are used solely to distinguish one entity or action from another entity or action, without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

As used herein, the term “and/or,” when used in a list of two or more items, means that any one of the listed items can be employed by itself, or any combination of two or more of the listed items can be employed. For example, if a composition or assembly is described as containing components A, B, and/or C, the composition or assembly can contain A alone; B alone; C alone; A and B in combination; A and C in combination; B and C in combination; or A, B, and C in combination.

The following disclosure describes a heating assembly for a cooking device. The heating assembly may include a burn box having a body defining a pot and a receptacle. The pot and receptacle can be separated from each other by a divider. An ignitor extends into the pot and ignites a fuel disposed within the pot. A duct is fluidly coupled with the receptacle or another portion of the burn box and is configured to extend between the receptacle and a housing surrounding the burn box. The duct defines an inlet operably coupled with the receptacle and an outlet on the opposing end portion of the duct. As fuel is burned within the pot, a byproduct of the combustion process may fall into the receptacle. A vacuum device may be operably coupled with the duct and remove the byproduct from the receptacle through the duct.

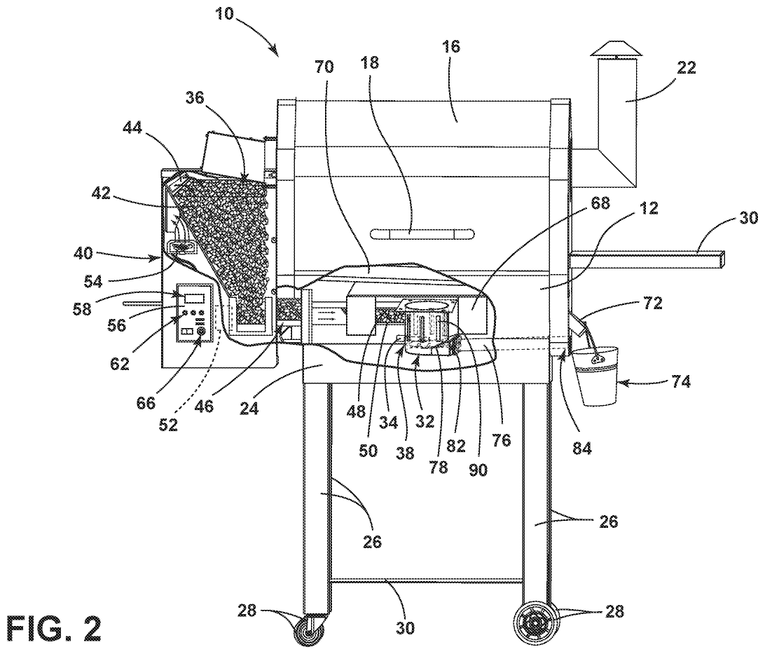

Referring to FIGS. 1 and 2, a cooking device 10 includes a housing 12 that defines a heating chamber 14 in which food items to be prepared may be placed. In some examples, the housing 12 includes a movable lid 16 for providing and inhibiting access to the heating chamber 14. A handle 18 can be positioned on the lid 16 to enable a user to move the lid 16 between an open position, an example of which is illustrated in FIG. 1, and a closed position, an example of which is illustrated in FIG. 2. In some examples, the cooking device 10 may include one or more racks 20 upon which an item may be placed. During operation, the lid 16 can be closed so as to retain heat and/or smoke supplied to the heating chamber 14 for food preparation. The cooking device 10 may also include one or more exhaust conduits 22 to remove heat and/or smoke from the heating chamber 14. The exhaust conduit 22 may be selectively closed and/or altered to adjust the heating characteristics within the chamber 14.

The housing 12 may be coupled to a support structure 24 that includes one or more legs 26. Any of the legs 26 may be operably coupled with a swivel caster and/or a wheel 28 to facilitate movement of the cooking device 10. A shelf 30 may be operably coupled with the support structure 24 and/or supported by one or more of the legs 26. Additionally, and/or alternatively, a shelf 30 may be operably coupled with the housing 12 and extend therefrom. It will be appreciated that the cooking device 10 may be any type of cooking device. As non-limiting examples, the cooking device 10 may be a grill, smoker, air fryer, oven, brazier, steamer, roaster, fryer, broiler, stove, and/or toaster oven. While the cooking device 10 may be any type of cooking device 10, the present disclosure will be described with continuing reference to a grill, which may utilize pellets as a fuel. Those of ordinary skill in the art will be able to apply the features set forth herein to other types of cooking devices 10 using the description of the present disclosure in the non-limiting example of a grill.

Referring still to FIGS. 1 and 2, the cooking device 10 can be shaped to have an enclosed inner chamber, i.e., the heating chamber 14, which may be heated by a heating assembly 32. The heating assembly 32 can include an ignitor 34 that may independently produce heat. Additionally, and/or alternatively, the ignitor 34 may be configured to ignite a fuel 36 and/or sustain a burning of the fuel 36 to produce heat within the heating chamber 14, which may occur in a burn box 38.

In some examples, the fuel 36 may be stored in a hopper 40, or any other type of container, and may consist of wood pellets 42 for producing the heat and/or smoke. In some instances, the pellets 42 are loaded into the hopper 40 through movement of a panel 44 from a closed position to an open position thereby providing access into the hopper 40. The pellets 42 may be transported from the hopper 40 using an auger assembly 46. The auger assembly 46 may include an auger 48 centrally positioned in a channel 50 that may extend along the heating chamber 14. The channel 50 includes openings or the like that place the channel 50 and/or the auger 48 in gaseous communication with the heating chamber 14. When the auger 48 is rotated within the channel 50 by a motor 52, pellets 42 are drawn from the hopper 40 and transported via the auger 48 through the channel 50 to the burn box 38. One or more ignitors 34 (e.g., electrical ignitors) locally heat the wood pellets 42 within the burn box 38 and cause the pellets 42 to emit heat and/or smoke within the heating chamber 14. The auger assembly 46 may further include one or more fans 54 that direct airflow through the channel 50, the burn box 38, and/or through the heating chamber 14. In some instances, the circulated air may also be directed towards and/or within the burn box 38 to assist in the combustion of the fuel 36 within the burn box 38.

It will be appreciated that the cooking device 10 of the present disclosure may use any desired fuel 36 for heating the heating chamber 14. As non-limiting examples, the fuel 36 for the cooking device 10 may be wood (e.g., wood pellets), stick burners, natural gas, charcoal, gas, and/or an electrical heating unit. The heating assembly 32 may sustain a temperature inside the cooking device 10 of around 100 to 800 degrees Fahrenheit for cooking the food items. In some examples, the cooking device 10 may be capable of automatic (without human intervention) regulation of the temperature inside the cooking device 10 to a predetermined set temperature or temperature range. Due to the potentially high heat environment, various components of the cooking device 10 may be made of any desired heat-resistant material(s). As non-limiting examples, various portions of the cooking device 10 may be made of stainless steel and/or cast iron.

With further reference to FIGS. 1 and 2, a control unit 56 for controlling the operation of the cooking device 10 may house, be integrated within, or otherwise installed on the hopper 40. The control unit 56 may additionally or alternatively be positioned on any portion of the cooking device 10 and/or remotely coupled with the cooking device 10. In some instances, the control unit 56 can control the auger 48 and/or operation of the heating assemblies 32. However, the control unit 56 may perform any other function and it is also contemplated that the cooking device 10 may have multiple control units 56 at various locations, which may be tethered to or remotely positioned from the cooking device 10, to control any function of the cooking device 10.

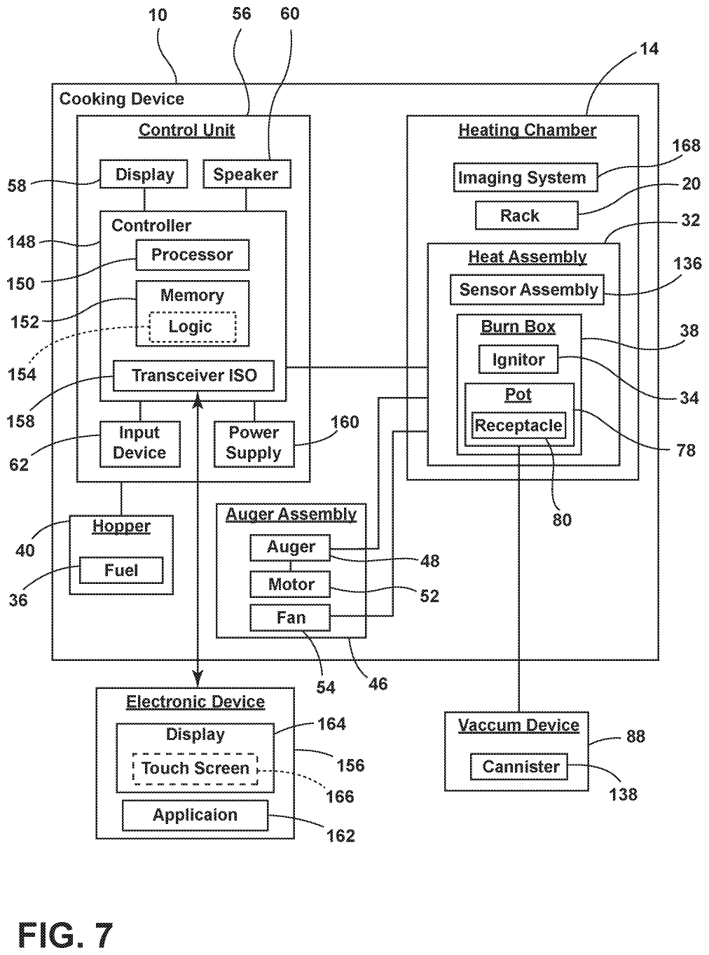

The control unit 56 may further include a display 58 for providing a status of an operation of the cooking device 10, a speaker 60 (FIG. 7) for producing audible notifications to a user, an input device 62 for accommodating user input, a cabinet temperature sensor for determining the temperature inside the chamber 14, a probe 64 for determining a temperature of the food being cooked, a timer module for setting the cooking time for the cooking device 10, a probe temperature set module for setting the internal temperature of the food product based on the user's preference for the cooked food, a display control relay for powering the display 58 and input device 62, and/or a heating assembly control relay for cycling the ignitor ON and OFF. The probe 64 may be electronically coupled with one or more input/output (I/O) ports 66 positioned on the control unit 56. The I/O ports 66 may be configured in any manner and may interact and/or couple with a wide array of devices.

Still referring to FIGS. 1 and 2, a heat plate 68 may be positioned between the burn box 38 and the rack 20. The heat plate 68 may accept heat from the heating assembly 32 and dissipate heat therefrom. In some instances, the heat plate 68 may be wider than the burn box 38, to increase a heated area below the rack 20. In some examples, the heat plate 68 may produce infrared heat that is utilized for cooking the food items within the heating chamber 14. A drain pan 70 can be positioned between the heat plate 68 and the racks 20 for collecting run-off grease and fallen particles during the cooking process. The drain pan 70 is slanted towards a side portion of the heating chamber 14, which includes an outlet channel, allowing some of the grease to flow downward and through a discharge port 72. In some instances, a bucket 74, container, tray, or the like may be positioned at the discharge port 72 to collect the run-off grease and fallen particles.

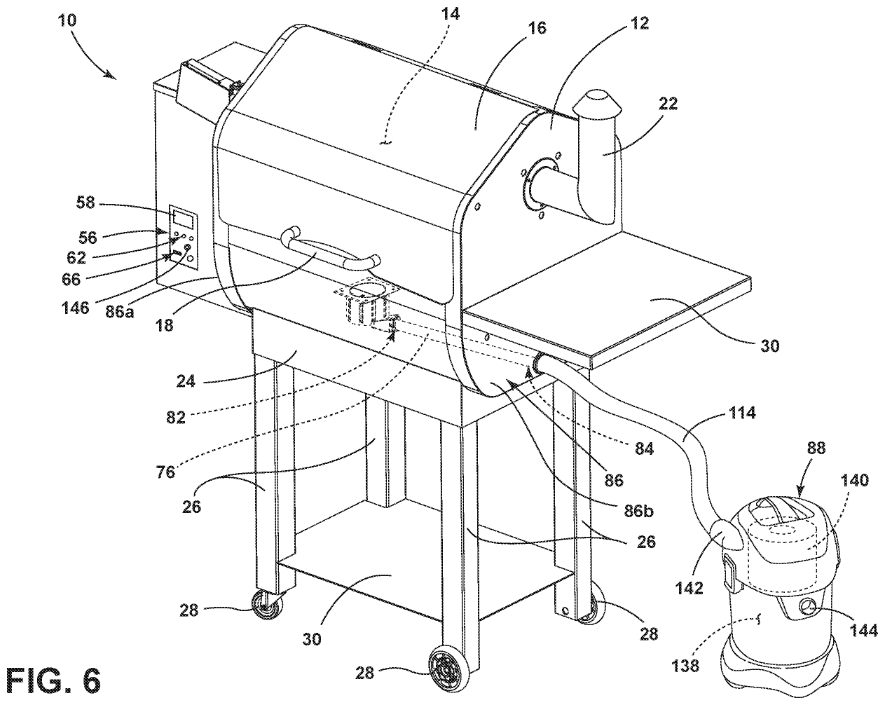

Referring still to FIGS. 1 and 2, in some examples, the heating assembly 32 may further include a duct 76 operably coupled with the burn box 38. As will be provided in more detail below, the burn box 38 may include a pot 78 and a receptacle 80 configured to retain a byproduct, such as ash, that is produced during the cooking process within the pot 78. A first end portion 82 of the duct 76 may be fluidly coupled with the receptacle 80. A second end portion 84 of the duct 76 may terminate proximate a side portion 86 of the housing 12. A vacuum may be produced within the duct 76 by a vacuum device 88 (FIG. 6) or through any other device that produces a suction within the duct 76 to remove the byproduct within the receptacle 80 from the cooking device 10.

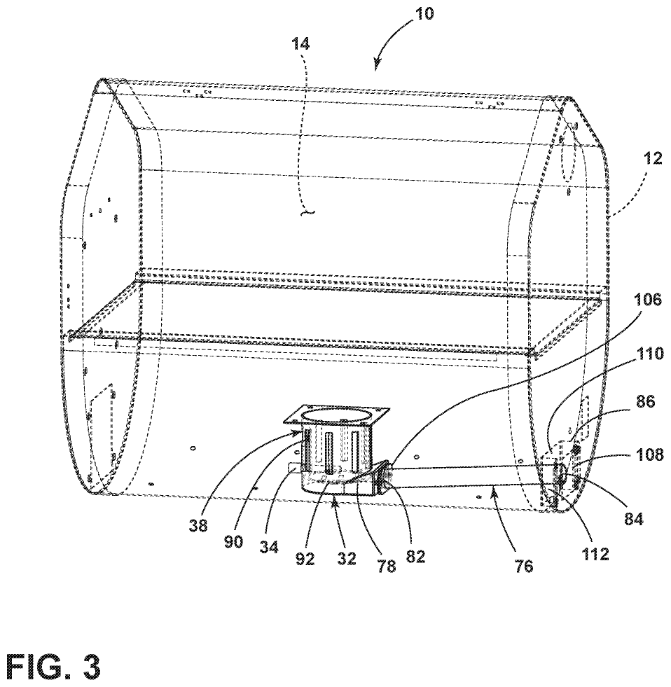

Referring now to FIGS. 3-5, in some examples, the burn box 38 includes a body 90 that defines the pot 78 and the receptacle 80 separated by a divider 92. The body 90 may extend in a first direction and the duct 76 may be extends between the burn box 38 and the housing 12 in a second, intersecting direction. The pot 78 may have a peripheral portion 94 that defines an upper opening 96 at one end of the peripheral portion 94 and a bottom portion defined by the divider 92. The upper opening 96 is positioned closer to the rack 20 than the bottom portion. The pot 78 receives the fuel 36 delivered by the auger assembly 46, which may be placed within the pot 78 through a void defined by the peripheral portion 94 and/or the fuel 36 may be delivered through the upper opening 96. Once positioned within the pot 78, the fuel 36 is ignited by the ignitor 34 and/or by combusting fuel 36 previously disposed within the pot 78 to produce heat/smoke. The peripheral portion 94 defines vents 98 therein to assist in the combustion of the pellets 42 within the burn box 38. In some instances, air may be forced through the vents 98 by the fan 54 to further assist in combustion of the fuel 36 within the burn box 38.

The receptacle 80 may at least partially be positioned on an opposing side of the divider 92 from the pot 78. As the fuel pellets 42 burn, a byproduct, such as ash, is produced. The byproduct falls through apertures 100 defined by the divider 92 into the receptacle 80 below. In some instances, the byproduct accumulates in the receptacle 80 below the vents 98 and, therefore, at least a portion of the combustion air flow produced by the fan 54 occurs between the vents 98 and the upper opening 96 of the pot 78, which is external from the receptacle 80. Consequently, circulation of the byproduct by the combustion air flow into the heating chamber 14 is minimized thereby reducing an amount of byproduct deposited on the food within the heating chamber 14.

In some examples, the receptacle 80 includes a first portion 102 positioned on an opposing side of the divider 92 from the pot 78 and a second portion 104 that is laterally offset from the pot 78. The side portion 86 may be positioned on an opposing side of the burn box 38 from the channel 50 of the auger assembly 46. Thus, in some examples, the channel of the auger assembly 46 may extend between a first side portion (e.g., 86a) of the housing 12 and the burn box 38 and the duct 76 may extend between the burn box 38 and a second, opposing side portion (e.g., 86b) of the housing 12.

Referring back to FIGS. 3-6, in some examples, a first bracket 106 may operably couple the duct 76 to the second portion 104 of the receptacle 80. A second bracket 108 may operably couple to the housing 12 and may support the duct 76 proximate the second end portion 84 of the duct 76. The second bracket 108 may be attached to an interior surface of the housing 12 through fasteners, weldment, adhesives, and/or through another fixation process. The second bracket 108 may define an opening and the duct 76 may extend through the opening. The second end portion of the duct 76 may also extend through the housing 12. The opening may be defined by a vertical portion 110 that is offset from the side portion of the housing 12 by one or more peripheral portions 112. The vertical portion 110 and the peripheral portions 112 may be integrally formed or coupled with one another.

Each of the first and second brackets 106, 108 may be formed from any desired heat-resistant material(s), such as a metallic material (e.g., stainless steel and/or cast iron), a polymeric material, an elastomeric material, combinations thereof, and/or any other practicable material. Each of the first and second brackets 106, 108 may additionally be formed through any practicable manufacturing process, including stamping and/or bending.

In some examples, the vacuum device 88 may be fluidly coupled with the duct 76 and the byproduct within the receptacle 80 may be moved through the duct 76 when a vacuum is produced therein. In some instances, the vacuum device 88 may include a hose 114 (FIG. 6) that is positioned around the duct 76. The hose 114 may be placed against a gasket 116 that may also be circumferentially positioned around the second end portion 84 of the duct 76 and may be coupled to the housing 12. In some examples, the gasket 116 assists in creating a partially sealed engagement between the gasket 116 and the hose 114 to increase the efficiency of the vacuum within the duct 76. The gasket 116 may be formed from any practicable material, including silicon or another material tolerant of high temperatures (i.e., temperatures over 100 degrees Fahrenheit).

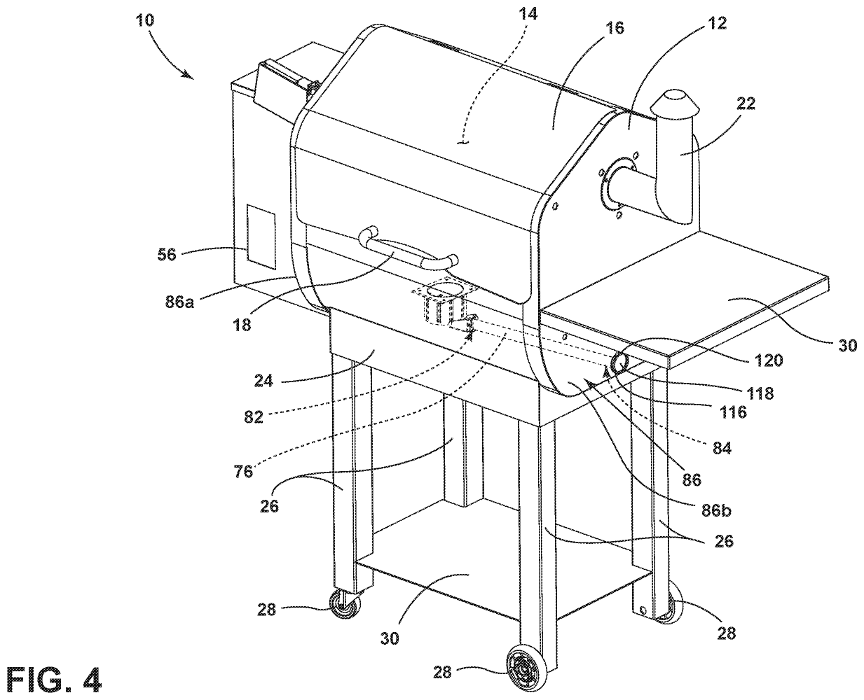

With further reference to FIG. 4, a cover assembly 118 is configured to shroud, or at least partially cover, a second end portion 84 of the duct 76. The cover assembly 118 may be operably coupled to the housing 12 and moved between a first position, wherein access to the duct 76 may be inhibited, and a second position, wherein access to the duct 76 is possible. In some examples, the cover assembly 118 may be rotated from a closed position to an open position about a pivot assembly 120. The pivot assembly 120 may be an anchor about which the cover assembly 118 rotates, a dampener or other mechanical device that assists in rotation of the cover assembly 118, or an electrical device (such as a servo motor) that electrically moves the cover assembly 118 between the first and second position when a switch 146 (FIG. 6) is actuated. The switch 146 may be any type of switch 146 without departing from the scope of the present disclosure. For example, the switch 146 may be configured as a proximity switch that provides a sense activation field to sense contact or close proximity (e.g., within one millimeter) of an object, such as the hand (e.g., palm or finger(s)) of a user in relation to the switch 146. Proximity switches of any type can be used, such as, but not limited to, capacitive sensors, inductive sensors, optical sensors, temperature sensors, resistive sensors, the like, or a combination thereof. It will also be appreciated that the switch 146 may alternatively be a mechanical switch of any type known in the art, such as a push button. In other examples, the cover assembly 118 may be any other type of assembly that may be coupled with the housing 12 or other portions of the cooking device 10, such as a magnetic assembly.

In some examples, at least one of the speaker 60 and the display 58 may provide a notification when the cover assembly 118 is moved from a closed position to an open position within a predefined duration of time after activation of the ignitor 34 and/or while the ignitor 34 is activated. For instance, the control unit 56 may monitor a temperature within the heating chamber 14 and/or monitor the predefined duration of time since deactivation of the ignitor 34. Based on either of these inputs, the control unit 56 may determine whether there is a chance that the byproduct may still be hot or above a predefined temperature. If there is a likelihood that the byproduct is still above the predefined temperature, the notification may warn a user about the removal of the byproduct through the duct 76 while the temperature is elevated. In various examples in which the cover assembly 118 includes an electrical device, the electrical device may be configured to move between the first and second positions when there is a likelihood that the byproduct is below the predefined temperature and maintained in the closed position when there is a likelihood that the byproduct is still above the predefined temperature.

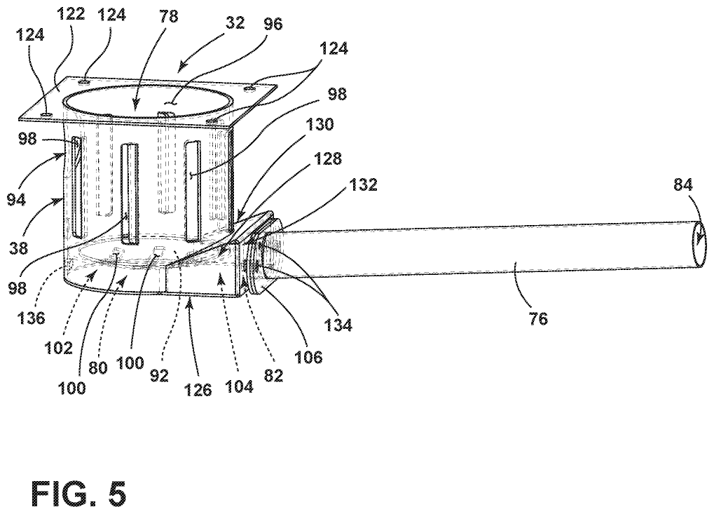

Referring to FIG. 5, a mounting plate 122 may be coupled or integrally formed with a top portion of the body 90, or any other portion, for supporting the burn box 38 in a substantially fixed location within the heating chamber 14. The mounting plate 122 may define one or more fastener voids 124 through which fasteners are inserted from removably coupling the burn box 38 to an anchoring position within the heating chamber 14 and/or may be maintained through any other structure.

The receptacle 80 of the burn box 38 includes a first portion 102 that is at least partially vertically aligned with the pot 78 and a second portion 104 that is laterally offset from the pot 78. The divider 92 is configured to support a fuel source thereon and a byproduct, such as ash, produced by burning the fuel source is configured to move from the pot 78 to the receptacle 80 through the one or more apertures 100 defined by the divider 92. The byproduct may fall through the divider 92 and into the first portion 102 and/or the second portion 104 of the receptacle 80. In some examples, as generally illustrated in FIG. 5, the second portion 104 of the receptacle 80 may have a bottom surface 126 that is vertically aligned and/or integrally formed with the first portion 102 of the receptacle 80. Opposing side surfaces 128 extend vertically from the bottom surface 126. A top surface 130 of the second portion 104 may have an angled orientation relative to the bottom surface 126 (i.e., the top and bottom surfaces 130, 126 may be non-parallel one another). A face surface 132 also extends upwardly from the bottom surface 126 and between the opposing side surfaces. The face surface 132 may define an opening therein through which the first end portion 82 of the duct 76 may extend, or the first end portion 82 of the duct 76 may be operably coupled with the opening. In other examples, the opening may be defined by any other portion of the body 90 of the burn box 38.

The first bracket 106 may be configured as one or more planar panels that also define an opening through which the duct 76 may extend. One or more fastener voids 134 may also be defined by the first bracket 106. Respective fasteners may be positioned through the fastener voids 134 and couple with the face surface 132, or extend therethrough, for removable maintaining the duct 76 in fluid connection with the receptacle 80.

In some examples, a sensor assembly 136 may be positioned within the receptacle 80 that is configured to detect at least one of a temperature of the byproduct within the receptacle 80 and an amount of byproduct within the receptacle 80. The sensor assembly 136 is electrically coupled with the control unit 56 and may provide a notification in regards to various conditions. In examples including a temperature sensor, the control unit 56 may lock the cover assembly 118 or notify a user of a raised temperature within the receptacle 80 if a user attempts to move the cover assembly 118 to the open position. In various examples, the temperature sensor may be configured as a negative temperature coefficient (NTC) thermistor, a resistance temperature detector (RTD), a thermocouple, a semiconductor-based sensor, and/or any other device capable of measuring a temperature within the receptacle 80.

In examples including a fill-level sensor, the control unit 56 may notify a user that an amount of byproduct within the receptacle 80 is above a predefined amount. In response, the user may use the duct 76 to remove the byproduct from the receptacle 80. In various examples, the fill-level sensor may be configured as one or more float switches, capacitive sensors, optical detectors (e.g., LED and photodiode), pressure sensors, weight sensors (e.g., a load cell), and others.

Referring to FIG. 6, as provided herein, the vacuum device 88 may be used to remove the byproduct from the receptacle 80 and may be configured as a wet/dry vacuum, i.e., capable of picking up both wet and dry material. The vacuum device 88 includes a collection canister 138 and a power unit 140 secured to the collection canister 138. The power unit 140 houses a motor and impeller assembly for establishing vacuum pressure within the vacuum device 88. A vacuum hose 114 is configured so that one end can be inserted into an air inlet 142 formed in the vacuum device 88. In some examples, the hose 114 is friction-fitted into air inlet 142. An air outlet 144 is also formed on the vacuum device 88 for exhausting air from the canister 138.

As provided herein, the hose 114 may be positioned around the second end portion 84 of the duct 76 and create a vacuum or suction within the receptacle 80, the burn box 38, and/or the housing 12. When the suction is created, byproduct within the receptacle 80, the burn box 38, and/or the housing 12 may be moved through the duct 76 and into the hose 114. From the hose 114, the byproduct may be transported to the collection canister 138 where the byproduct can then be disposed of. As provided herein, the cooking device 10 may include a cover assembly 118 that may inhibit a user from placing the hose 114 about the second end portion of the duct 76 and/or at least partially inhibit removal of the byproduct through the duct 76 when the cover assembly 118 is positioned in the closed position. In some instances, a user may be warned that removal of the byproduct from the cooking device 10 may not be recommended due to the increased temperature of the byproduct. In some examples, the cover assembly 118 may be precluded from movement from the closed position while the byproduct may be at an increased temperature. The raised temperature may be any temperature that is greater than the temperature of ambient air surrounding the cooking device 10 and/or a temperature exceeding a predefined value.

In some examples, the vacuum device 88 may be powered be one of the ports 66 on the control unit 56. In instances in which the vacuum device 88 receives power from the control unit 56, various user preferences and/or instructions may be inputted through the input device 62 of the control unit 56 for activation/deactivation of the vacuum device 88. In some instances, power may additionally or alternatively be provided to the vacuum device 88 from power sources remotely positioned from the cooking device power, such as plugging the vacuum device 88 into an electrical outlet thereby coupling the vacuum device 88 to the electrical grid. The switch 146 on the control unit 56 may activate/deactivate the vacuum device 88 by manually toggling the switch 146 between a first state and a second state.

Referring to FIG. 7, in some examples, the control unit 56 includes a controller 148 having a processor 150 and memory 152. Logic 154 is stored within the memory 152 and includes one or more routines that is executed by the processor 150. The controller 148 includes any combination of software and/or processing circuitry suitable for controlling various components of the cooking device 10 described herein including without limitation processors, microcontrollers, application-specific integrated circuits, programmable gate arrays, and any other digital and/or analog components, as well as combinations of the foregoing, along with inputs and outputs for transceiving control signals, drive signals, power signals, sensor signals, and so forth. All such computing devices and environments are intended to fall within the meaning of the term “controller” or “processor” as used herein unless a different meaning is explicitly provided or otherwise clear from the context.

In some examples, the cooking device 10 may communicate via wired and/or wireless communication with one or more handheld or electronic devices 156 through a transceiver 158. The communication may occur through one or more of any desired combination of wired (e.g., cable and fiber) and/or wireless communication mechanisms and any desired network topology (or topologies when multiple communication mechanisms are utilized). Exemplary wireless communication networks include a wireless transceiver (e.g., a BLUETOOTH module, a ZIGBEE transceiver, a Wi-Fi transceiver, an IrDA transceiver, an RFID transceiver, etc.), local area networks (LAN), and/or wide area networks (WAN), including the Internet, cellular, satellite, microwave, and radio frequency, providing data communication services.

With further reference to FIG. 7, the controller 148 receives power through a power source 160. In operation, when powered, the controller 148 may activate/deactivate a motor 52 that rotates the auger 48 within the auger assembly 46 to move fuel 36 from the hopper 40 to the heating assembly 32. The motor 52 may be configured as any type of motor, including, but not limited to, an AC brushless motor, a DC brushed motor, a DC brushless motor, a direct drive motor, a linear motor, a servo motor, a stepper motor, and/or any other practicable motor. An ignitor 34 within the heating assembly 32 ignites the fuel 36 to generate heat/smoke within the heating chamber 14 that cooks a food item positioned therein, which may be placed on the rack 20. To assist in directing the heat/smoke through the heating chamber 14, the fan 54 may direct airflow through the channel 50 of the auger assembly 46 and into the heating chamber 14. The fan 54 may also direct air towards the heating assembly 32 to assist in the combustion of the fuel 36 within the burn box 38. The fan 54 may be of any practicable type without departing from the teachings provided herein. The cooking device 10 may be additionally or alternatively include a valve and/or another non-electronically powered device for regulating the fuel 36. In some examples, the fuel 36 may be remotely positioned from the cooking device 10 without departing from the teachings of the present disclosure.

The electronic device 156 may be any one of a variety of computing devices and may include a processor and memory. The memory may store logic having one or more routines that is executable by the processor. For example, the electronic device 156 may be a cell phone, mobile communication device, key fob, wearable device (e.g., fitness band, watch, glasses, jewelry, wallet), apparel (e.g., a tee shirt, gloves, shoes or other accessories), personal digital assistant, headphones and/or other devices that include capabilities for wireless communications and/or any wired communications protocols. The electronic device 156 may have an application 162 thereon and a display 164 may provide a graphical user interface (GUI) and/or various types of information to a user. The operation of the various components of the cooking device 10 may be altered through the usage of the application 162 and/or information regarding the operation of the components may be illustrated on the display 164. The electronic device 156 may likewise have any combination of software and/or processing circuitry suitable for controlling the cooking device 10 described herein including without limitation processors, microcontrollers, application-specific integrated circuits, programmable gate arrays, and any other digital and/or analog components, as well as combinations of the foregoing, along with inputs and outputs for transceiving control signals, drive signals, power signals, sensor signals, and so forth.

In some examples, the electronic device 156 may be configured to receive user inputs via the touchscreen circuitry 166 on the display 164. The inputs may relate to a type of food item positioned within the heating chamber 14 and may be based on an automatic detection of the food item and/or user provided information as to a type of food item. In response, the application 162 and/or the controller 148 may provide suggested cooking operations. The inputs may also relate to a desired cooking temperature, which in turn, produces varying amounts of byproduct. In some examples, through the sensor assembly 136 within the burn box 38, the controller 148 may provide information regarding the temperature, the fill-level, and/or any other information to the user through the electronic device 156. Accordingly, usage of the cooking device 10 may be varied through the usage of the application 162 in addition to or in lieu of usage of the input device 62. Additionally or alternatively, the electronic device 156 may also provide feedback information, such as visual, audible, and tactile alerts. The feedback information may be provided for any reason, including but not limited to, error notifications, byproduct exceeding a predefined fill level in the receptacle 80, food item cooked notifications, timing notifications, etc.

In some instances, the cooking device 10 may include an imaging system 168. In such instances, one or more imagers within the imaging system 168 may include an area-type image sensor, such as a CCD or a CMOS image sensor, and image-capturing optics that captures an image of an imaging field of view defined by the image-capturing optics. The captured image may be illustrated on the display 164 of the electronic device 156. In some instances, successive images may be captured and provided on the display 164 to create a video. The images may be used to monitor the food item, to determine whether to alter a temperature of the heating chamber 14, to verify proper functioning of the cooking device 10, and/or for any other purpose.

As provided herein, the vacuum device 88 may be used to move byproduct from the burn box 38 to an external canister 138. In some examples, the vacuum device 88 may be powered by the control unit 56. Moreover, in some instances, the vacuum device 88 may be activated/deactivated by the control unit 56 and/or the electronic device 156. For example, when the controller 148 determines that the byproduct accumulation within the receptacle 80 is above a predefined amount, the controller 148 may activate the vacuum device 88 to remove the byproduct from the receptacle 80 automatically and/or with user intervention. In some examples, the vacuum device 88 may additionally and/or alternatively be activated/deactivate through the usage of the application 162 of the electronic device 156 automatically and/or with user intervention.

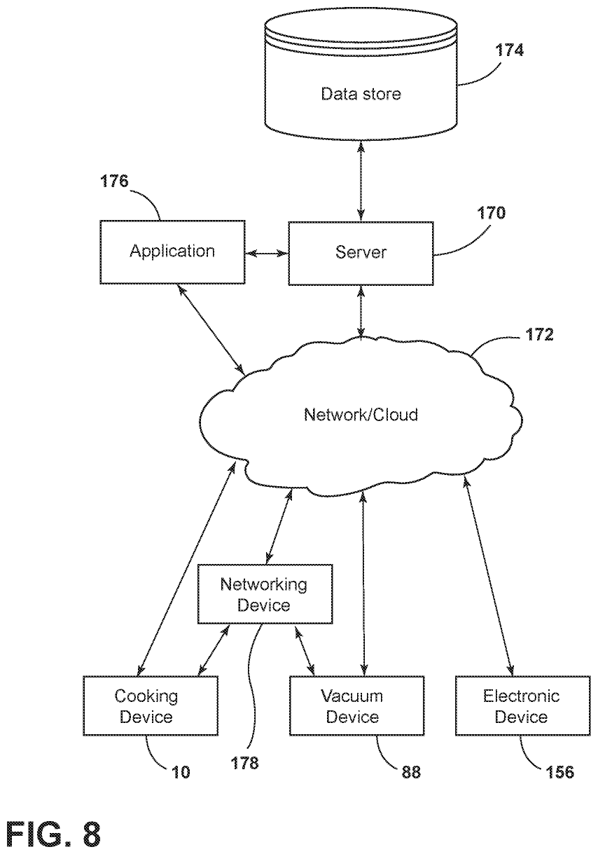

Referring to FIG. 8, in some examples, the cooking device 10, the electronic device 156, and/or the vacuum device 88 may be communicatively coupled with one or more remote sites such as a remote server 170 via a network/cloud 172. The network/cloud 172 represents one or more systems by which the cooking device 10, the electronic device 156, and/or the vacuum device 88 may communicate with the remote server 170. Accordingly, the network/cloud 172 may be one or more of various wired or wireless communication mechanisms, including any desired combination of wired and/or wireless communication mechanisms and any desired network topology (or topologies when multiple communication mechanisms are utilized). Exemplary communication networks 172 include wireless communication networks (e.g., using Bluetooth, IEEE 802.11, etc.), local area networks (LAN) and/or wide area networks (WAN), including cellular networks, satellite networks, microwave networks, radio frequency networks, the Internet and the Web, which all may provide data communication services and/or cloud computing services. The Internet is generally a global data communications system that is a hardware and software infrastructure, which provides connectivity between computers. In contrast, the Web is generally one of the services communicated via the Internet. The Web is generally a collection of interconnected documents and other resources, linked by hyperlinks and URLs. In many technical illustrations when the precise location or interrelation of Internet resources are generally illustrated, extended networks such as the Internet are often depicted as a cloud (e.g. 172 in FIG. 8). The verbal image has been formalized in the newer concept of cloud computing. The National Institute of Standards and Technology (NIST) provides a definition of cloud computing as “a model for enabling convenient, on-demand network access to a shared pool of configurable computing resources (e.g., networks, servers, storage, applications, and services) that can be rapidly provisioned and released with minimal management effort or service provider interaction.” Although the Internet, the Web, and cloud computing are not exactly the same, these terms are generally used interchangeably herein, and they may be referred to collectively as the network/cloud 172.

The server 170 may be one or more computer servers, each of which may include at least one processor and at least one memory, the memory storing instructions executable by the processor, including instructions for carrying out various steps and processes. The server 170 may include or be communicatively coupled to a data store 174 for storing collected data as well as instructions for operating the cooking device 10, the control unit 56 (FIG. 7), the vacuum device 88, etc. that may be directed to and/or implemented by the cooking device 10 and/or the vacuum device 88 with or without intervention from a user and/or the electronic device 156.

In some examples, the instructions may be inputted through the electronic device 156 and relayed to the server 170. Those instructions may be stored in the server 170 and/or data store 174. At various predefined periods and/or times, the cooking device 10 and/or the vacuum device 88 may communicate with the server 170 through the network/cloud 172 to obtain the stored instructions, if any exist. Upon receiving the stored instructions, the cooking device 10 and/or the vacuum device 88 may implement the instructions. The server 170 may additionally store information related to multiple cooking devices 10, food items, usage characteristics, errors, durations to obtain a byproduct fill level, etc. and operate and/or provide instructions to the cooking device 10, the vacuum device 88, the electronic device 156 in conjunction with the stored information with or without intervention from a user.

With further reference to FIG. 8, the server 170 also generally implements features that may enable the cooking device 10 and/or the vacuum device 88 to communicate with cloud-based applications 176. Communications from the cooking device 10 can be directed through the network/cloud 172 to the server 170 and/or cloud-based applications 176 with or without a networking device 178, such as a router and/or modem. Additionally, communications from the cloud-based applications 176, even though these communications may indicate one of the cooking device 10 and/or the vacuum device 88 as an intended recipient, can also be directed to the server 170. The cloud-based applications 176 are generally any appropriate services or applications 176 that are accessible through any part of the network/cloud 172 and may be capable of interacting with the cooking device 10 and/or the vacuum device 88.

In various examples, the electronic device 156 can be feature-rich with respect to communication capabilities, i.e. have built-in capabilities to access the network/cloud 172 and any of the cloud-based applications 176 or can be loaded with, or programmed to have, such capabilities. The electronic device 156 can also access any part of the network/cloud 172 through industry standard wired or wireless access points, cell phone cells, or network nodes. In some examples, users can register to use the remote server 170 through the electronic device 156, which may provide access the cooking device 10 and/or the vacuum device 88 and/or thereby allow the server 170 to communicate directly or indirectly with the cooking device 10 and/or the vacuum device 88. In various instances, the cooking device 10 and/or the vacuum device 88 may also communicate directly, or indirectly, with the electronic device 156 or one of the cloud-based applications 176 in addition to communicating with or through the server 170. According to some examples, the cooking device 10 and/or the vacuum device 88 can be preconfigured at the time of manufacture with a communication address (e.g. a URL, an IP address, etc.) for communicating with the server 170 and may or may not have the ability to upgrade or change or add to the preconfigured communication address.

Referring still to FIG. 8, when a new cloud-based application 176 is developed and introduced, the server 170 can be upgraded to be able to receive communications for the new cloud-based application 176 and to translate communications between the new protocol and the protocol used by the cooking device 10 and/or the vacuum device 88. The flexibility, scalability, and upgradeability of current server technology render the task of adding new cloud-based application protocols to the server 170 relatively quick and easy.

The cooking device of the present disclosure may offer a variety of advantages. For instance, use of the heating assembly provided herein may allow for separation of combustion byproduct and fuel while heating the heating chamber, which may create a more efficient heating assembly. Moreover, the storage of the byproduct below a pot of the burn box can at least partially remove the byproduct from airflow within the pot thereby minimizing the amount of product circulated through the heating chamber. The receptacle of the burn box is operably coupled with a duct that allows for easy removal of the byproduct from the heating chamber. For instance, the byproduct may be removed from the heating chamber without having to move various components within the heating chamber, such as the rack. A cover may be positioned over a second end portion of the duct to prevent heated byproduct from being removed from the receptacle and/or the retain heat in the heating chamber. The temperature of the byproduct may be determined based on a sensor assembly within the burn box and/or through an assumption of byproduct temperature based on the amount of time that the ignitor is deactivated. An electronic device may be communicatively coupled with the cooking device and/or the vacuum device and configured to receive information relating to the fill-level of the receptacle, the temperature of the byproduct, and/or any other information. The electronic device and/or the cooking device may also be configured to activate/deactivate the vacuum device. The cooking device, the electronic device, and/or the vacuum device may communicate directly with one another or through the cloud with one another. Based on communication with the cloud, the operation of the cooking device and/or the vacuum device may be altered.

It will be understood by one having ordinary skill in the art that construction of the described invention and other components is not limited to any specific material. Other exemplary examples of the invention disclosed herein may be formed from a wide variety of materials unless described otherwise herein.

For purposes of this disclosure, the term “coupled” (in all of its forms: couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

Furthermore, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected” or “operably coupled” to each other to achieve the desired functionality, and any two components capable of being so associated can also be viewed as being “operably couplable” to each other to achieve the desired functionality. Some examples of operably couplable include, but are not limited to, physically mateable and/or physically interacting components and/or wirelessly interactable and/or wirelessly interacting components and/or logically interacting and/or logically interactable components.

It is also important to note that the construction and arrangement of the elements of the invention as shown in the exemplary examples is illustrative only. Although only a few examples of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements shown as multiple parts may be integrally formed, the operation of the interfaces may be reversed or otherwise varied, the length or width of the structures and/or members or connectors or other elements of the system may be varied, the nature or number of adjustment positions provided between the elements may be varied. It should be noted that the elements and/or assemblies of the system might be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary examples without departing from the spirit of the present innovations.

It will be understood that any described processes or steps within described processes may be combined with other disclosed processes or steps to form structures within the scope of the present invention. The exemplary structures and processes disclosed herein are for illustrative purposes and are not to be construed as limiting.

It is also to be understood that variations and modifications can be made on the aforementioned structures and methods without departing from the concepts of the present invention, and further it is to be understood that such concepts are intended to be covered by the following claims unless these claims by their language expressly state otherwise.

What is claimed is:

1. A heating assembly for a cooking device, the heating assembly comprising:
a burn box having a body defining a pot and a receptacle, the pot and receptacle separated by a divider;
an ignitor extending into the pot; and
a duct fluidly coupled with the receptacle and extending between the receptacle and a housing surrounding the burn box, the duct defining an inlet operably coupled with the receptacle and an outlet on an opposing end portion of the duct.

2. The heating assembly of claim 1, further comprising:
a cover assembly configured to at least partially cover a second end portion of the duct.

3. The heating assembly of claim 2, wherein the cover assembly is rotated from a closed position to an open position about a pivot assembly.

4. The heating assembly of claim 1, wherein the ignitor is operably coupled with a control unit, the control unit configured to activate the ignitor to combust a fuel within the pot.

5. The heating assembly of claim 1, further comprising:
an auger assembly operably coupled with a hopper and the pot and configured to supply a fuel to the pot.

6. The heating assembly of claim 4, wherein the control unit further includes at least one of a speaker and a display and a notification is provided from at least one of the speaker or the display when a cover assembly is moved from a closed position to an open position within a predefined duration of time after activation of the ignitor.

7. The heating assembly of claim 1, wherein the divider defines one or more apertures therethrough and a byproduct is configured to fall through the one or more apertures.

8. The heating assembly of claim 7, wherein the byproduct within the receptacle may be moved through the duct when a vacuum is produced within the duct.

9. A cooking device comprising:
a housing defining a heating chamber;
a heating assembly operably coupled with the heating chamber;
a burn box positioned within the heating assembly and defining a pot and a receptacle separated by a divider; and
a duct fluidly coupled with the receptacle on a first end portion and extending from the burn box towards the housing.

10. The cooking device of claim 9, wherein the divider defines one or more apertures and a fuel is burned within the pot and byproduct produced during combustion of the fuel may move through the apertures.

11. The cooking device of claim 9, wherein a cover assembly is configured to at least partially cover a second end portion of the duct.

12. The cooking device of claim 9, wherein the receptacle includes a first portion positioned on an opposing side of the divider from the pot and a second portion that is laterally offset from the pot.

13. The cooking device of claim 9, further comprising:
a first bracket operably coupling the duct to the receptacle; and
a second bracket operably coupled with the housing and configured to support the duct proximate the second end portion.

14. The cooking device of claim 9, wherein a second end portion of the duct extends through the housing.

15. The cooking device of claim 14, further comprising:
a gasket circumferentially positioned around the second end portion of the duct and coupled to the housing.

16. A heating assembly for a cooking device, the heating assembly comprising:
a burn box configured to heat a heating chamber defined by a housing, the burn box having a body extending in a first direction; and
a duct fluidly coupled with the burn box and extends between the burn box and the housing in a second, intersecting direction.

17. The heating assembly of claim 16, wherein the burn box defines a pot separated from a receptacle by a divider, the divider defining one or more apertures therethrough.

18. The heating assembly of claim 17, wherein the receptacle includes a first portion that is at least partially vertically aligned with the pot and a second portion that is laterally offset from the pot.

19. The heating assembly of claim 17, wherein a divider is configured to support a fuel source thereon and a byproduct produced by burning the fuel source is configured to move from a pot to a receptacle through the one or more apertures defined by the divider.

20. The heating assembly of claim 19, wherein the byproduct is removed from the receptacle through the duct when a vacuum is produced within the duct.
